(19) United States
(12) Patent Application Publication
(10) Pub. No.: US 2004/0204891 A1
(43) Pub. Date: Oct. 14, 2004

(54) Semiconductor memory device having a test mode for testing an operation state

(75) Inventors: Shuichi Horihata, Hyogo (JP); Kenji Tokami, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/653,988

(22) Filed: Sep. 4, 2003

(30) Foreign Application Priority Data
Mar. 24, 2003 (JP) 2003-079965(P)

(51) Int. Cl. G06F 15/00

(52) U.S. Cl. 702/117

(57) ABSTRACT

A bit line equalize circuit equalizes one and the other of bit lines to one and the other of predetermined bit line potentials in response to activation of a bit line equalize signal, respectively. The one predetermined bit line potential on the one bit lines is higher than the other predetermined bit line potential on the other bit line. Thereby, a read error reflecting WL-BC(BL) shorting and WL-SC(SN) shorting can be detected further rapidly without increasing a circuit area.

### BACKGROUND OF THE INVENTION

1. Field of the Invention

The present invention relates to a semiconductor memory device, and particularly to a semiconductor memory device having a test mode for testing an operating state.

2. Description of the Background Art

In recent years, it has been increasingly required to reduce size and power consumption of semiconductor memory devices for reducing size and power consumption of electronic devices equipped with the semiconductor memory devices. In many cases, process change is employed for reducing size and power consumption of semiconductor memory devices such as a dynamic random access memory, which may be referred to as a “DRAM” hereinafter, and can achieve great effect on such reduction. The “process change” represents reduction in design rule of the semiconductor memory device, i.e., reduction in a ratio of (minimum interconnection space)/(interconnection width).

In these days, however, the process change has been rapidly performed in semiconductor memory devices, and margins for the process change in the semiconductor memory devices have been gradually decreasing in accordance with such rapid process change. Therefore, foreign matter, variations in process and others, which did not cause any problem in the past, are becoming manifest so that faults such as short circuit and current leakage are becoming significant.

Therefore, it becomes increasing necessary to conduct a complicated test or a long-time test for detecting faults in a memory cell array portion, which includes particularly many repetitive layout patters with minimum interconnection widths, as compared with other portions in a semiconductor memory device. In conventional DRAMs, faults such as short circuit and current leakage are detected by accelerating faulty signs, and this acceleration is achieved by DC/AC stress utilizing Wafer Burn-In (WBI), Burn-In or the like, or a sense amplifier delay mode delaying activation timing of a sense amplifier.

For example, a conventional semiconductor memory device disclosed in Japanese Patent Laying-Open No. 11-39899 includes a test mode determining circuit detecting signal information for starting a predetermined test, and a sense time control circuit, which receives an output signal of this test mode determining circuit and controls operation delay times of word lines and sense amplifiers. This semiconductor memory device can determine within a short time whether a memory cell having a small operation margin in data storing and holding operations is present or not.

In another conventional semiconductor memory device disclosed in Japanese Patent Laying-Open No. 2000-260200, two MOS transistors are turned on in response to reception of a signal at a H-level from a test signal generating circuit, and thereby apply a bit line setting voltage and an inverted voltage to paired bit lines, respectively. A sense amplifier connected to the bit line pair is differentially supplied with the bit line setting voltage and its inverted voltage so that an operation margin is measured.

However, the conventional semiconductor memory device disclosed in Japanese Patent Laying-Open No. 11-39899 uses the sense amplifier delay mode so that burn-in requires a long time in the processing of accelerating faulty signs such as short circuit and current leakage, and thus a long time is required for detecting faults in the semiconductor memory device.

In the conventional semiconductor memory device disclosed in Japanese Patent Laying-Open No. 2000-260200, an additional MOS transistor is required for applying the bit line setting voltage to the bit line pair in the operation of measuring the operation margin. This causes a problem of increase in circuit area.

### SUMMARY OF THE INVENTION

An object of the invention is to provide a semiconductor memory device, which can perform fault detection within a short time, and requires a small circuit area.

According to an aspect of the invention, a semiconductor memory device of a single-memory-cell structure having a test mode for testing an operation state, includes a plurality of word lines arranged in a row direction, a bit line pair arranged in a column direction, a plurality of memory cells configured such that only one of the memory cells on each of the plurality of word lines is arranged for the bit line pair, and corresponds to one bit line alternately in the bit line pair, a bit line equalize circuit equalizing potentials on the bit line pair, and a bit line isolation control circuit performing electrical connection and isolation of the paired bit lines. In the test mode, the bit line equalize circuit or the bit line isolation control circuit can control the potential on each of the paired bit lines independently of the other.

According to another aspect of the invention, a semiconductor memory device of a twin-memory-cell structure having a test mode for testing an operation state, includes a plurality of word lines arranged in a row direction, a bit line pair arranged in a column direction, a plurality of memory cells configured such that two of the memory cells arranged on each of the plurality of word lines correspond to the paired bit lines, respectively, a bit line equalize circuit equalizing potentials on the bit line pair, and a bit line isolation control circuit performing electrical connection and isolation of the paired bit lines. In the test mode, the bit line equalize circuit or the bit line isolation control circuit can control the potential on each of the paired bit lines independently of the other.

According to still another aspect of the invention, a semiconductor memory device having a test mode for testing an operation state, includes a plurality of word lines arranged in a row direction, a bit line pair arranged in a column direction, a first memory cell group connected to one of the paired bit lines supplied with a first cell plate potential, and a second memory cell group connected to the other of the paired bit lines supplied with a second cell plate potential.

According to the invention described above, it is possible to detect circuit faults more quickly without increasing a circuit area.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing a whole structure of a DRAM 13, which is an example of a semiconductor memory device according to an embodiment of the invention.

FIG. 2 is a circuit diagram partially showing a circuit structure of a memory mat 7 relating to a background of the invention.

FIG. 3A is a cross section showing a sectional structure of a memory cell 70 assumed as a short-circuited memory cell.

FIG. 3B is a circuit diagram showing a circuit structure of memory cell 70 assumed as a short-circuited memory cell.

FIG. 4 is a timing chart illustrating a circuit operation of memory cell 70 in memory mat 7 shown in FIG. 2 and relating to the background of the invention.

FIG. 5 is a circuit diagram partially showing a circuit structure of a memory mat 7A according to a first embodiment of the invention.

FIG. 6 is a timing chart illustrating a circuit operation of memory cell 70 in memory mat 7A according to the first embodiment shown in FIG. 5.

FIG. 7 is a circuit diagram partially showing a circuit structure of a memory mat 7B according to a second embodiment of the invention.

FIG. 8 is a timing chart illustrating a circuit operation of memory cell 70 in memory mat 7B according to the second embodiment shown in FIG. 7.

FIG. 9 is a circuit diagram partially showing a circuit structure of a memory mat 7C according to a third embodiment of the invention.

FIG. 10 is a timing chart illustrating a circuit operation of memory cell 70 in memory mat 7C according to the third embodiment shown in FIG. 9.

FIG. 11 is a circuit diagram partially showing a circuit structure of a memory mat 7D according to a fourth embodiment of the invention.

FIG. 12 is a timing chart illustrating a circuit operation of a memory cell 70a in memory mat 7D according to the fourth embodiment shown in FIG. 11.

### DESCRIPTION OF THE PREFERRED EMBODIMENTS

Embodiments of the invention will now be described with reference to the drawings. In the figures, the same or corresponding portions bear the same reference numbers, and description thereof is not repeated.

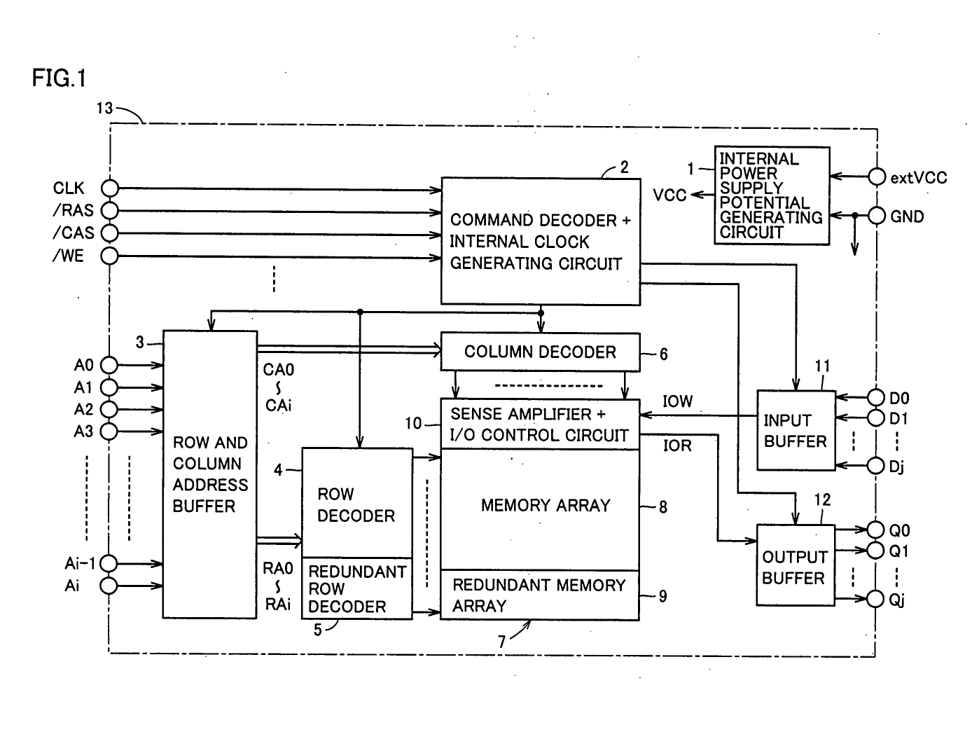

FIG. 1 is a schematic block diagram showing a whole structure of a DRAM 13, which is an example of a semiconductor memory device according to an embodiment of the invention.

First, a structure and an operation of whole DRAM 13 will be schematically described. DRAM 13 may be an SDRAM (Synchronous DRAM), and naturally may be another kind of DRAM.

Referring to FIG. 1, DRAM 13 includes an internal power supply potential generating circuit 1, a command decoder plus clock generating circuit 2, a row and column address buffer 3, a row decoder 4, a redundant row decoder 5, a column decoder 6, a memory mat 7, an input buffer 11 and an output buffer 12. Memory mat 7 includes a memory array 8, a redundant memory array 9 and a sense amplifier plus I/O control circuit 10.

Internal power supply potential generating circuit 1 receives an external power supply potential extVCC and a ground potential GND, and produces an internal power supply potential VCC, which is lower than external power supply potential extVCC and will be merely referred to as “power supply potential VCC” hereinafter, for providing it to whole DRAM 13. Power supply potential VCC can be tuned by a fuse group arranged in internal power supply potential generating circuit 1.

Based on externally applied signals CLK, /RAS, /CAS, /WE and others, command decoder plus clock generating circuit 2 generates an internal clock, and also selects a predetermined operation mode to control whole DRAM 13.

Row and column address buffer 3 produces row address signals RA0-RAi (where i is an integer equal to or larger than 0) and column address signals CA0-CAi based on externally applied address signals A0-Ai, and provides signals RA0-RAi and CA0-CAi thus produced to row decoders 4 and 5 and column decoder 6.

Memory array 8 includes a plurality of memory cells, which are arranged in rows and columns, and each can store one bit of data. Each memory cell is arranged in a predetermined address designated by row and column addresses.

Row decoder 4 designates the row address in memory array 8 in response to row address signals RA0-RAi provided from row and column address buffer 3.

Redundant row decoder 5 is provided with a fuse group for programming a row address of a faulty memory cell in memory array 8 as well as a row address in redundant memory array 9, which is to be replaced with the faulty row address. When the row address signal RA0-RAi corresponding to the faulty row address programmed by fuse group is received, row decoder 4 does not designate the received row address, and redundant row decoder 5 designates the programmed row address in redundant memory array 9 in substitution of the received row address. Thus, the faulty memory cell row including the faulty memory cell in memory array 8 is replaced with a normal memory cell row in redundant memory array 9.

Column decoder 6 designates the column address in memory array 8 in response to column address signal CA0-CAi provided from row and column address buffer 3.

Sense amplifier plus I/O control circuit 10 connects the memory cell in the address, which is designated by row decoder 4 (or redundant row decoder 5) and column decoder 6, to an end of data I/O line pair IOW for writing or data I/O line pair IOR for reading. The other end of write data I/O line pair IOW is connected to input buffer 11. The other end of read data I/O line pair IOR is connected to output buffer 12.

In a write mode, data Dj (where j is a natural number) is externally supplied via a Dj terminal, and input buffer 11 provides data Dj to the selected memory cell via write data I/O line pair IOW in accordance with logical combination of externally applied signals CLK, /RAS, /CAS, /WE and others.

In a read mode, output buffer 12 externally provides data Qj, which is read from the selected memory cell via read data I/O line pair IOR, from a Qj terminal in accordance with logical combination of externally applied signals CLK, /RAS, /CAS, /WE and others.

A portion in memory mat 7 of the foregoing whole structure of DRAM 13 provides a background relating to the invention, and this portion will now be described.

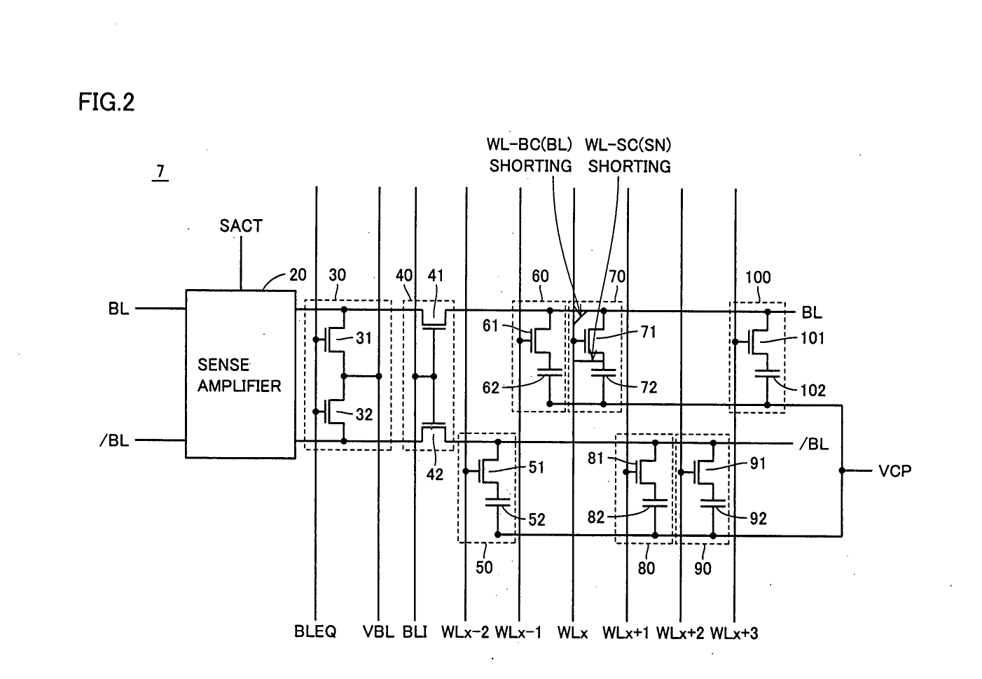

FIG. 2 is a circuit diagram partially showing a circuit structure of memory mat 7 relating to the background of the invention.

As shown in FIG. 2, memory mat 7 relating to the background of the invention includes a sense amplifier 20, a bit line equalize circuit 30, a bit line isolation control circuit 40, and memory cells 50, 60, 70, 80, 90 and 100.

Sense amplifier 20 is connected to bit line pair BL and /BL, and amplifies a minute potential difference, which is caused between pared bit lines BL and /BL by reading data from the memory cell, in response to activation of a sense amplifier activating signal SACT.

Bit line equalize circuit 30 includes N-channel MOS transistors 31 and 32, and equalizes bit line pair BL and /BL to a bit line potential VBL in accordance with activation of a bit line equalize signal BLEQ. Usually, bit line potential VBL is set to a half of power supply potential VCC.

Bit line equalize signal BLEQ becomes inactive in response to an externally applied activation signal (ACT command in the case of SDRAM). When bit line equalize signal BLEQ is inactive, bit line pair BL and /BL is floated to allow reading of data from the memory cell.

Bit line isolation control circuit 40 includes N-channel MOS transistors 41 and 42, and operates in accordance with bit line isolating signal BLI to connect or isolate electrically paired bit lines BL and /BL to or from each other. Thus, bit line isolation control circuit 40 electrically connects or isolates the side of sense amplifier 20 including bit line equalize circuit 30 to or from the side of memory cells 50-100 via bit line pairs BL and/BL.

Memory cell 50 is provided corresponding to word line WLx−2 and bit line /BL. Memory cell 60 is provided corresponding to word line WLx−1 and bit line BL. Memory cell 70 is provided corresponding to word line WLx and bit line BL. Memory cell 80 is provided corresponding to word line WLx+1 and bit line /BL. Memory cell 90 is provided corresponding to word line WLx+2 and bit line /BL. Memory cell 100 is provided corresponding to word line WLx+3 and bit line BL.

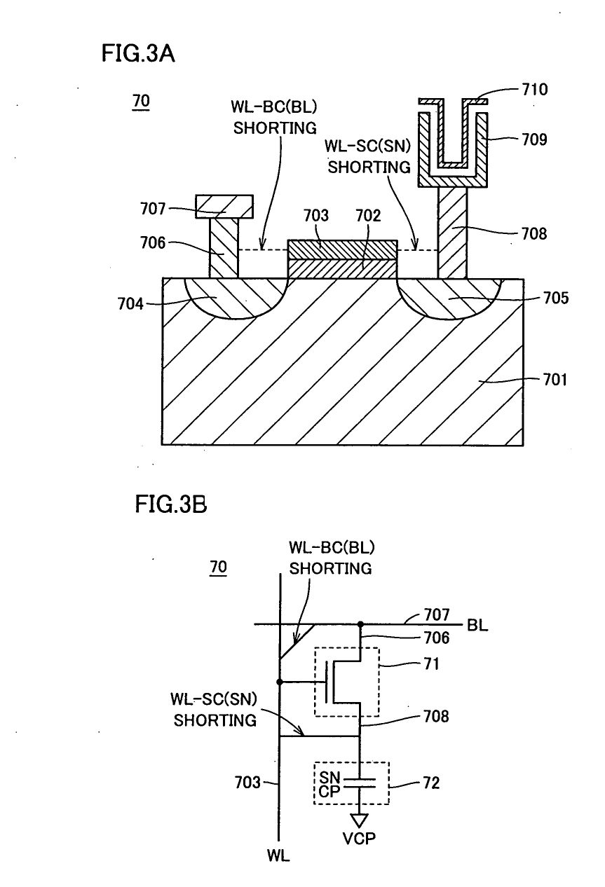

Memory cells 50, 60, 70, 80, 90 and 100 have the same structures, and each include an N-channel MOS transistor and a capacitor. It is assumed that memory cell 70 has a short-circuited interconnection, and specific description will now be given on memory cell 70 with reference to FIGS. 3A and 3B.

FIG. 3A shows a sectional structure of memory cell 70. Memory cell 70 shown in FIG. 3A has a semiconductor substrate 701 of a P-type. A gate electrode 702 is formed on semiconductor substrate 701 with a gate insulating layer (not shown) therebetween. A word line (WL) layer 703 is formed on gate electrode 702.

Heavily doped N⁺-type impurity regions 704 and 705 having a relatively high impurity concentration are formed on opposite sides of gate electrode 702, respectively, and each are located in a region extending from a main surface of semiconductor substrate 701 to a predetermined depth.

A bit line (BL) layer 707 is formed on heavily doped impurity region 704 with a bit line contact (BC) layer 706 therebetween. It is assumed that word line layer 703 and bit line contact layer 706 are short-circuited in memory cell 70. This short circuit will be referred to as a “WL-BC(BL) shorting” hereinafter.

A storage node (SN) region 709 having a concave section is formed above heavily doped impurity region 705 with a storage node contact (SC) layer 708 therebetween. It is also assumed that word line layer WL 703 and storage node contact layer 708 are short-circuited in memory cell 70. This short circuit will be referred to as a “WL-SC(SN) shorting” hereinafter.

A cell plate region 710 having a concave section is formed above storage node region 709 with a capacitor region therebetween.

FIG. 3B shows a circuit structure of memory cell 70. Memory cell 70 shown in FIG. 3B includes an N-channel MOS transistor 71 for accessing and a capacitor 72 for data storage.

N-channel MOS transistor 71 has a gate connected to word line WL and a drain (source) connected to bit line BL. Capacitor 72 has an end connected to the source (drain) of N-channel MOS transistor 71 via storage node SN, and the other thereof is supplied with a cell plate potential VCP via a cell plate CP. Usually, cell plate potential VCP is set to a half of power supply potential VCC.

In memory cell 70 shown in FIG. 3B, it is already assumed that WL-BC(BL) shorting is present between word line WL and bit line BL, and WL-SC(SN) shorting is present between word line WL and sense node SN.

Referring to FIG. 2 again, description will now be given on a circuit operation of memory cell 70 having the short-circuited portions described above. When word line WL is selected and attains a H-level, bit line BL and storage node SN shown in FIGS. 3A and 3B are pulled up to the H-level at the same time. Therefore, an error occurs in memory cell 70 because the reading, which is allowed when storage node SN is at the L-level, is not performed.

However, if the short-circuited portions have high resistance values, the fault may not be manifest in the normal mode. In this case, a test mode called “sense amplifier delay mode” can be effectively employed for manifesting the fault. Description will now be given on this sense amplifier delay mode (which may also be referred to as a “SA delay mode” hereinafter).

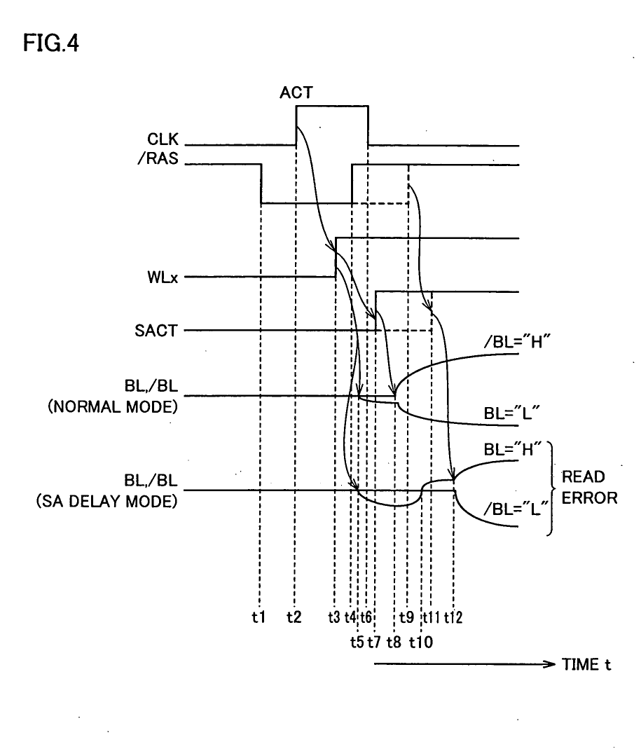

FIG. 4 is a timing chart illustrating the circuit operation of memory cell 70 in memory mat 7 (FIG. 2) relating to the background of the invention.

First, the normal mode is described for comparison.

At a time t1, externally applied row address strobe signal /RAS (see FIG. 1) attains the L-level.

At a time t2, externally applied clock signal CLK (see FIG. 1) attains the H-level, and an ACT command is issued. By receiving this ACT command, word line WLx rises to the H-level at a time t3.

Since word line WLx rises to the H-level at time t3, data is read from memory cell 70 in FIG. 2 onto bit line BL. By receiving the data thus read, the potential on bit line BL shifts to the L-level at a time t5.

At a time t4, row address strobe signal /RAS attains the H-level, and clock signal CLK attains the L-level at a time t6. In response to the rising of word line WLx to the H-level at time t3, sense amplifier activating signal SACT rises to the H-level at a time t7.

In response to the rising of sense amplifier activating signal SACT to the H-level at time t7, sense amplifier 20 in FIG. 2 amplifies a minute potential difference on bit line pair BL and /BL (i.e., between paired bit lines BL and /BL) at a time t8. Consequently, paired bit lines BL and /BL attain the L- and H-levels, respectively, and the fault does not become apparent in the normal mode although the WL-BC(BL) shorting and WL-SC(SN) shorting are present in memory cell 70.

An operation in the sense amplifier delay mode will now be described.

In the sense amplifier delay mode, the rising of row address strobe signal /RAS is delayed from time t4 to a time t9.

Since the rising of row address strobe signal /RAS is delayed from time t4 to time t9, a rising time of sense amplifier activating signal SACT is delayed from a time t7 to a time t11. Thereby, a time when the minute potential difference on bit line pair BL and /BL is amplified is delayed from time t8 to a time t12.

Since WL-BC(BL) shorting and WL-SC(SN) shorting are present in memory cell 70, the potential on bit line BL, which shifted to the L-level at time t5, changes from the L-level toward the H-level due to an influence by a minute current flowing from word line WLx to bit line BL with the passage of time.

As a result, the potential on bit line BL changes from the L-level to the H-level at a time t10. When the minute potential difference on bit line pair BL and /BL is amplified at time t12, paired bit lines BL and /BL attains the H- and L-levels, respectively, and a read error reflecting the WL-BC(BL) shorting and WL-SC(SN) shorting in memory cell 70 is detected.

As described above, the sense amplifier delay mode produces a certain effect on detection of the faults such as the WL-BC(BL) shorting and WL-SC(SN) shorting in memory cells.

However, if manifestation of faults in the memory cell is to be accelerated only by the sense amplifier delay mode as described above, the test would require a long time. This test time increases with decrease in leak current, and such decreasing is caused by reduction in design rules of semiconductor memory device in recent years.

Therefore, if the manifestation of faults in the memory cell is to be accelerated only by the sense amplifier delay mode as described above, it is necessary for reducing the test time to increase a leak current to a certain extent by the burn-in or the like. An embodiment for overcoming this problem will now be described in detail as a first embodiment.

### FIRST EMBODIMENT

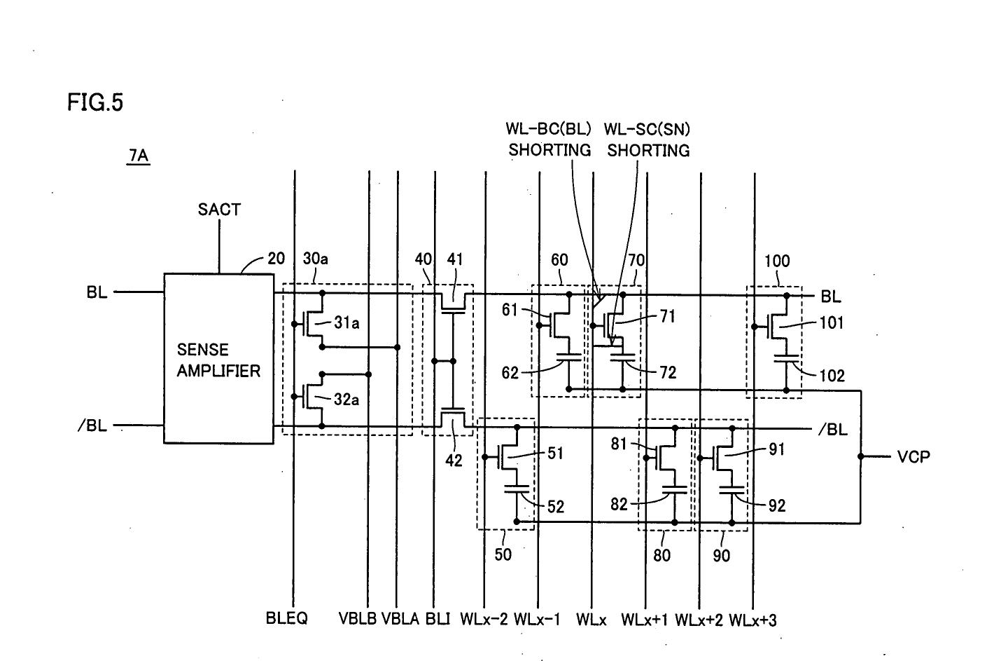

FIG. 5 is a circuit diagram partially showing a circuit structure of a memory mat 7A according to the first embodiment of the invention.

As shown in FIG. 5, a memory mat 7A of the first embodiment differs from that of memory mat 7, which is already described in connection with the background of the invention, in that a bit line equalize circuit 30a is used instead of bit line equalize circuit 30.

Bit line equalize circuit 30a includes N-channel MOS transistors 31a and 32a. N-channel MOS transistor 31a equalizes bit line BL to bit line potential VBLA in response to the activation of bit line equalize signal BLEQ. N-channel MOS transistor 32a equalizes bit line /BL to bit line potential VBLB in response to the activation of bit line equalize signal BLEQ.

Thus, bit line equalize circuit 30a in the first embodiment equalizes bit lines BL and /BL to bit line potentials VBLA and VBLB in response to the activation of bit line equalize signal BLEQ, respectively.

Bit line potentials VBLA and VBLB are different from each other only in the sense amplifier delay mode, and are equal to each other in the normal mode. Thus, in the normal mode, bit line equalize circuit 30a of the first embodiment is equivalent to bit line equalize circuit 30 relating to the background of the invention. Bit line potentials VBLA and VBLB can be externally controlled, e.g., by directly applying them via external pins.

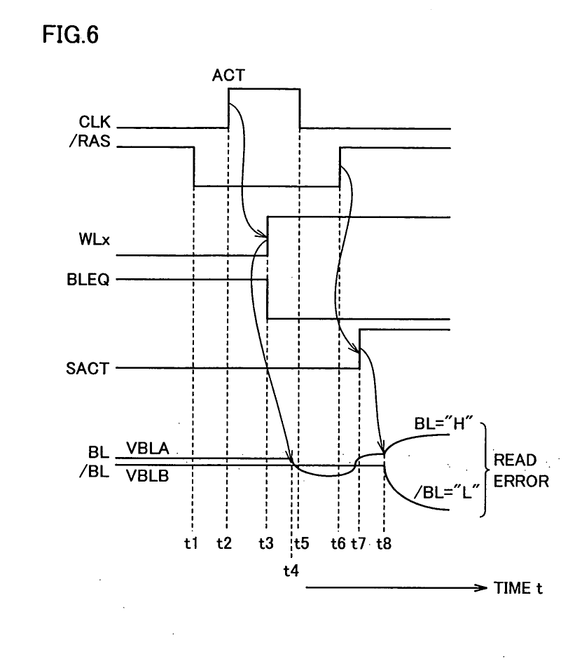

FIG. 6 is a timing chart illustrating a circuit operation of memory cell 70 in memory mat 7A of the first embodiment shown in FIG. 5.

FIG. 6 illustrates a sense amplifier delay mode. Therefore, paired bit lines BL and /BL in the initial state are equalized to bit line potentials VBLA and VBLB (VBLA>VBLB), respectively.

At time t1, externally applied row address strobe signal /RAS (see FIG. 1) attains the L-level.

At time t2, externally applied clock signal CLK (see FIG. 1) attains the H-level, and the ACT command is issued. In response to this ACT command, word line WLx rises to the H-level at time t3.

Bit line equalize signal BLEQ falls to the L-level simultaneously with the rising of word line WLx to the H-level at time t3. Since word line WLx rises to the H-level, data is read from memory cell 70 in FIG. 5 onto bit line BL. Since bit line equalize signal BLEQ falls to the L-level, bit line pair BL and /BL is floated. Since data is read onto floated bit line BL, the potential on bit line BL shifts toward the L-level at time t4.

Clock signal CLK attains the L-level at time t5, and row address strobe signal /RAS attains the H-level at time t6. At time t7, sense amplifier activating signal SACT rises to the H-level in response to the H-level of row address strobe signal /RAS attained at time t6.

In response to the H-level of sense amplifier activating signal SACT attained at time t7, sense amplifier 20 in FIG. 5 amplifies the minute potential difference on bit line pair BL and /BL at time t8.

Since the WL-BC(BL) shorting and WL-SC(SN) shorting are present in memory cell 70, the potential on bit line BL, which shifted toward the L-level at time t4, is affected by the minute current flowing from word line WLx to bit line BL, and changes from the L-level toward the H-level with time.

Accordingly, when the minute potential difference on bit line pair BL and /BL is amplified at time t8, paired bit lines BL and /BL attain the H-and L-levels, respectively. Consequently, a read error reflecting the WL-BC(BL) shorting and WL-SC(SN) shorting in memory cell 70 is detected.

In the sense amplifier delay mode according to the first embodiment, since potential VBLA on bit line BL in the initial state is higher than potential VBLB on bit line /BL, the potential on bit line BL shifted toward the L-level at time t4 changes relatively rapidly from the L-level to the H-level.

Thereby, the read error reflecting the WL-BC(BL) shorting and WL-SC(SN) shorting in memory cell 70 can be detected further rapidly.

According to the first embodiment, as described above, a potential difference is caused between bit line potential VBLA on bit line BL and bit line potential VBLB on bit line /BL so that the faults in the circuit can be rapidly detected without increasing a circuit area.

### SECOND EMBODIMENT

The first embodiment has been described in connection with the DRAM of the single-memory-cell structure, in which one memory cell is selected corresponding to each word line, and to one of the paired bit lines alternately. In recent years, however, DRAMs of a twin-memory-cell structure have been increasing. In the twin-memory-cell structure, two memory cells are selected corresponding to each word line, and to the paired bit lines respectively.

In the DRAM of the twin-memory-cell structure, since complementary data are always read from memory cells onto the bit line pair, such an advantage can be achieved that the read operation is stable as compared with the DRAM of the single-memory-cell structure, and a memory cell capacity can be apparently doubled.

However, if a fault such as WL-BC(BL) shorting or WL-SC(SN) shorting occurs in the memory cell, it is difficult in the DRAM of the twin-memory-cell structure to accelerate the manifestation of the fault by the sense amplifier delay mode or the like, as compared with the DRAM of the single-memory-cell structure.

This is because complementary data are read onto paired bit lines in the sense amplifier delay mode of the DRAM of the twin-memory-cell structure, and therefore a very long time is required before a leak current inverts the potential difference between the paired bit lines, as compared with the DRAM of the single-memory-cell structure.

The above problems can be overcome by replacing bit line equalize circuit 30 with bit line equalize circuit 30a, as is done in the first embodiment. However, other structures and manners overcoming the above problem are described below in connection with second, third and fourth embodiments.

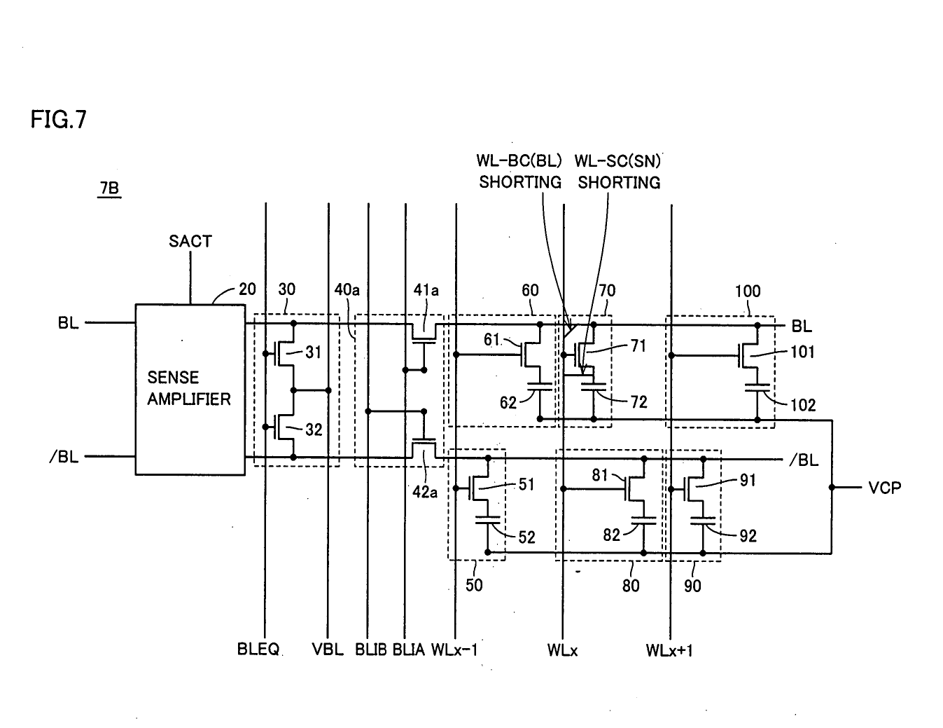

FIG. 7 is a circuit diagram partially showing a circuit structure of a memory mat 7B in the second embodiment of the invention.

As shown in FIG. 7, a memory mat 7B of the second embodiment includes sense amplifier 20, bit line equalize circuit 30, a bit line isolation control circuit 40a, and memory cells 50, 60, 70, 80, 90 and 100.

Sense amplifier 20 and bit line equalize circuit 30 are similar to those in memory mat 7 already described in connection with the background of the invention with reference to FIG. 2, and therefore, description thereof is not repeated.

Bit line isolation control circuit 40a includes N-channel MOS transistors 41a and 42a. N-channel MOS transistor 41a electrically connects or isolates bit line BL in accordance with bit line isolating signal BLIA. N-channel MOS transistor 42a electrically connects or isolates bit line /BL in accordance with bit line isolating signal BLIB.

Thus, bit line isolation control circuit 40a in the second embodiment electrically connects or isolates bit line BL in accordance with bit line isolating signal BLIA, and electrically connects or isolates bit line /BL in accordance with bit line isolating signal BLIB.

Bit line isolating signals BLIA and BLIB are different from each other only in the sense amplifier delay mode, and are equal to each other in the normal mode. Thus, bit line isolation control circuit 40a in the second embodiment is equivalent to bit line isolation control circuit 40 in the first embodiment during the normal mode.

Memory cell 50 is provided corresponding to word line WLx−1 and bit line /BL. Memory cell 60 is provided corresponding to word line WLx−1 and bit line BL. Memory cell 70 is provided corresponding to word line WLx and bit line BL. Memory cell 80 is provided corresponding to word line WLx and bit line /BL. Memory cell 90 is provided corresponding to word line WLx+1 and bit line /BL. Memory cell 100 is provided corresponding to word line WLx+1 and bit line BL.

As described above, memory cells 50-100 in the second embodiment are configured such that memory cells 50 and 60 share word line WLx−1, memory cells 70 and 80 share word line WLx, and memory cells 90 and 100 share word line WLx+1.

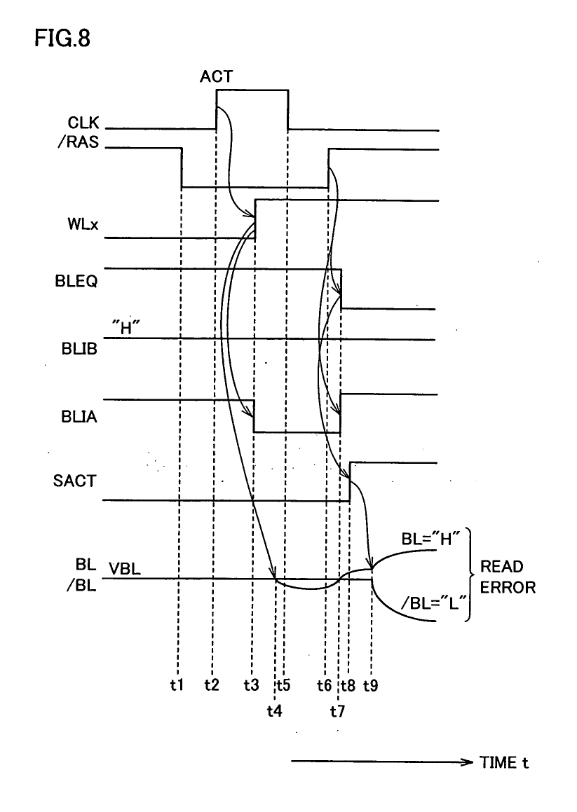

FIG. 8 is a timing chart illustrating a circuit operation of memory cell 70 in memory mat 7B of the second embodiment shown in FIG. 7.

FIG. 8 illustrates a sense amplifier delay mode. Paired bit lines BL and /BL are both equalized to bit line potential VBL in the initial state.

At time t1, externally applied row address strobe signal /RAS (see FIG. 1) attains the L-level.

At time t2, externally applied clock signal CLK (see FIG. 1) attains the H-level, and the ACT command is issued. In response to this ACT command, word line WLx rises to the H-level at time t3.

Simultaneously with the rising of word line WLx to the H-level at time t3, bit line isolating signal BLIA falls. However, bit line isolating signal BLIB continuously keeps the H-level. In response to the falling of bit line isolating signal BLIA, only bit line BL in bit line pair BL and /BL changes from the state, in which it is equalized to bit line potential VBL, to the floating state.

Therefore, in response to the falling of bit line isolating signal BLIA at time t3, the potential on only bit line BL in bit line pair BL and /BL shifts toward the L-level at time t4.

At time t5, clock signal CLK attains the L-level. At time t6, row address strobe signal /RAS attains the H-level. In response to the H-level of row address strobe signal /RAS attained at time t6, bit line equalize signal BLEQ falls to the L-level at time t7, and simultaneously, bit line isolating signal BLIA rises to the H-level.

In response to the falling of bit line equalize signal BLEQ at time t7, sense amplifier activating signal SACT rises to the H-level at time t8. In response to the rising of sense amplifier activating signal SACT to the H-level at time t8, sense amplifier 20 in FIG. 7 amplifies the minute potential difference on bit line pair BL and /BL at time t9.

Since WL-BC(BL) shorting and WL-SC(SN) shorting are present in memory cell 70, the potential on bit line BL, which shifted toward the L-level at time t4, is affected by the minute current flowing from word line WLx to bit line BL, and thereby changes from the L-level toward the H-level with time.

Therefore, when the minute potential difference between paired bit lines BL and /BL is amplified at time t9, paired bit lines BL and /BL attain the H- and L-levels, respectively. Consequently, a read error reflecting the WL-BC(BL) shorting and WL-SC(SN) shorting in memory cell 70 is detected.

In the sense amplifier delay mode of the second embodiment, bit line isolating signals BLIA and BLIB, which are provided for paired bit lines BL and /BL, respectively, are set independently of each other so that only one of the paired bit lines is floated in the data read operation.

In the data read operation, therefore, the potential on only one of the paired bit lines shifts toward the L-level (or H-level) so that the potential on bit line BL, which shifted toward the L-level at time t4, changes relatively rapidly from the L-level to the H-level.

Thereby, a read error reflecting the WL-BC(BL) shorting and WL-SC(SN) shorting in memory cell 70 can be detected further rapidly.

According to the second embodiment, as described above, the semiconductor memory device having the twin-memory-cell structure is configured such that bit line isolating signals BLIA and BLIB independent of each other are set for paired bit lines BL and /BL, respectively. Thereby, circuit faults can be detected further rapidly without increasing the circuit area.

### THIRD EMBODIMENT

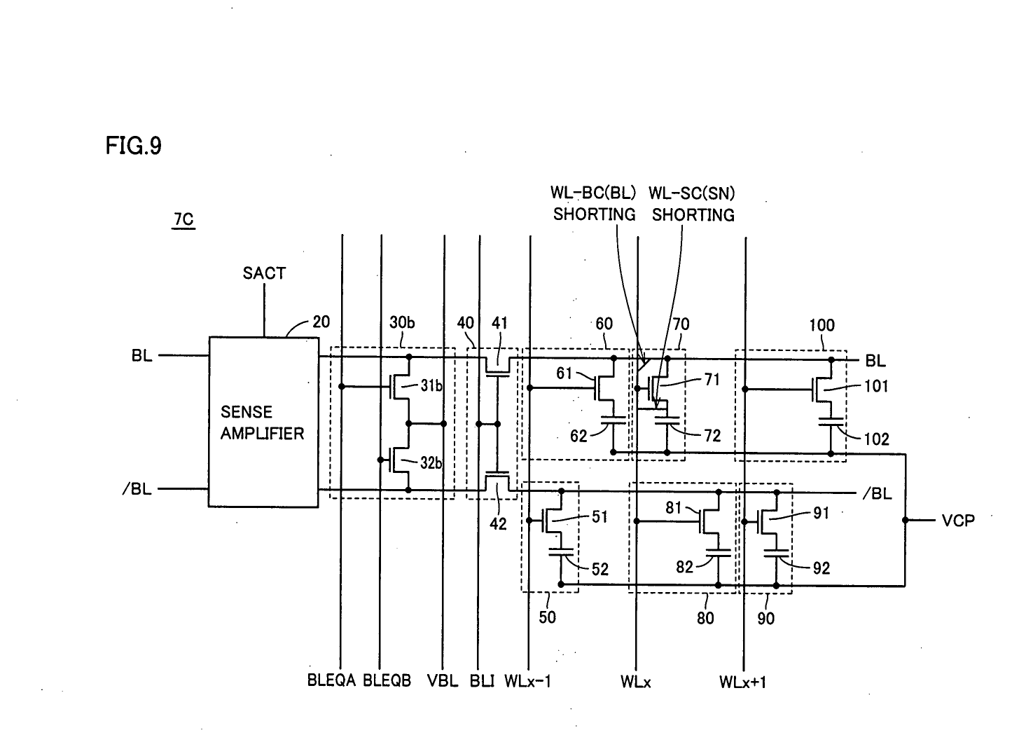

FIG. 9 is a circuit diagram partially showing a circuit structure of a memory mat 7C according to a third embodiment of the invention.

As shown in FIG. 9, memory mat 7C of the third embodiment includes sense amplifier 20, a bit line equalize circuit 30b, bit line isolation control circuit 40, and memory cells 50, 60, 70, 80, 90 and 100.

Sense amplifier 20 and bit line isolation control circuit 40 are similar to those in memory mat 7 already described in connection with the background of the invention with reference to FIG. 2, and therefore, description thereof is not repeated. Since memory cells 50-100 provide the twin-memory-cell structure similar to that of memory mat 7 of the second embodiment shown in FIG. 7, description thereof is not repeated.

Bit line equalize circuit 30b includes N-channel MOS transistors 31b and 32b. N-channel MOS transistor 31b equalizes bit line BL to bit line potential VBL in response to the activation of a bit line equalize signal BLEQA. N-channel MOS transistor 32b equalizes bit line /BL to bit line potential VBL in response to the activation of a bit line equalize signal BLEQB.

Thus, bit line equalize circuit 30b in the third embodiment equalizes bit line BL to bit line potential VBL in response to the activation of bit line equalize signal BLEQA, and equalizes bit line /BL to bit line potential VBL in response to the activation of bit line equalize signal BLEQB.

Thus, bit line equalize signals BLEQA and BLEQB are different from each other only in the sense amplifier delay mode, and are equal to each other in the normal mode. Thus, bit line equalize circuit 30b in the third embodiment is equivalent to bit line equalize circuit 30 in the second embodiment.

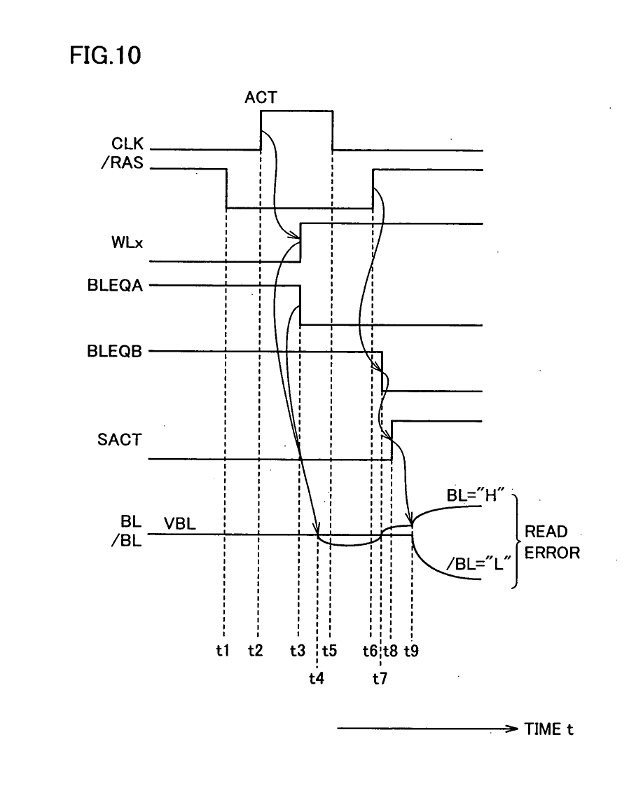

FIG. 10 is a timing chart illustrating a circuit operation of memory cell 70 in memory mat 7C of the third embodiment shown in FIG. 9.

FIG. 10 illustrates a sense amplifier delay mode. Paired bit lines BL and /BL are both equalized to bit line potential VBL in the initial state.

At time t1, externally applied row address strobe signal /RAS (see FIG. 1) attains the L-level.

At time t2, externally applied clock signal CLK (see FIG. 1) attains the H-level, and the ACT command is issued. In response to this ACT command, word line WLx rises to the H-level at time t3.

Simultaneously with the rising of word line WLx to the H-level at time t3, bit line equalize signal BLEQA falls to the L-level. In response to the falling of bit line equalize signal BLEQA, only bit line BL in bit line pair BL and /BL changes from the state, in which it is equalized to bit line potential VBL, to the floating state.

Therefore, in response to the falling of bit line equalize signal BLEQA at time t3, the potential on only bit line BL in bit line pair BL and /BL shifts toward the L-level at time t4.

At time t5, clock signal CLK attains the L-level. At time t6, row address strobe signal /RAS attains the H-level. In response to the H-level of row address strobe signal /RAS attained at time t6, bit line equalize signal BLEQB falls to the L-level at time t7.

In response to the falling of bit line equalize signal BLEQB at time t7, sense amplifier activating signal SACT rises to the H-level at time t8. In response to the rising of sense amplifier activating signal SACT to the H-level at time t8, sense amplifier 20 in FIG. 9 amplifies the minute potential difference on bit line pair BL and /BL at time t9.

Since WL-BC(BL) shorting and WL-SC(SN) shorting are present in memory cell 70, the potential on bit line BL, which shifted toward the L-level at time t4, is affected by the minute current flowing from word line WLx to bit line BL, and thereby changes from the L-level toward the H-level with time.

Therefore, when the minute potential difference between paired bit lines BL and /BL is amplified at time t9, paired bit lines BL and /BL attain the H- and L-levels, respectively. Consequently, a read error reflecting the WL-BC(BL) shorting and WL-SC(SN) shorting in memory cell 70 is detected.

In the sense amplifier delay mode of the third embodiment, bit line equalize signals BLEQA and BLEQB, which are provided for paired bit lines BL and /BL, respectively, are set independently of each other so that only one of the paired bit lines is floated in the data read operation.

In the data read operation, therefore, the potential on only one of the paired bit lines shifts toward the L-level (or H-level) so that the potential on bit line BL, which shifted toward the L-level at time t4, changes relatively rapidly from the L-level to the H-level.

Thereby, a read error reflecting the WL-BC(BL) shorting and WL-SC(SN) shorting in memory cell 70 can be detected further rapidly.

According to the third embodiment, as described above, the semiconductor memory device having the twin-memory-cell structure is configured such that bit line equalize signals BLEQA and BLEQB independent of each other are set for paired bit lines BL and /BL, respectively. Thereby, circuit faults can be detected further rapidly without increasing the circuit area.

### FOURTH EMBODIMENT

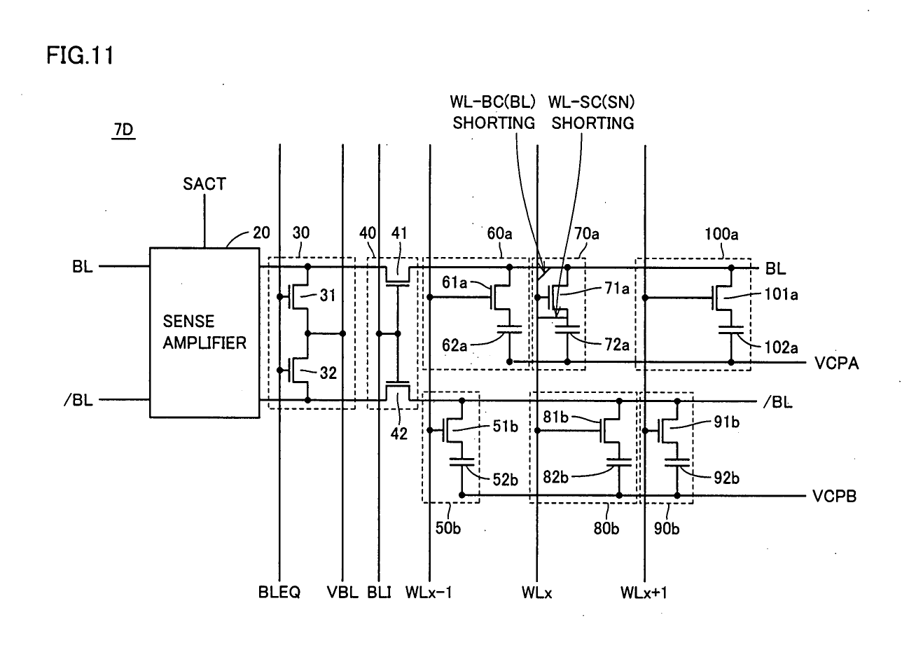

FIG. 11 is a circuit diagram partially showing a circuit structure of a memory mat 7D according to a fourth embodiment of the invention.

As shown in FIG. 11, memory mat 7D of the fourth embodiment includes sense amplifier 20, bit line equalize circuit 30, bit line isolation control circuit 40, and memory cells 50b, 60a, 70a, 80b, 90b and 100a.

Sense amplifier 20, bit line equalize circuit 30 and bit line isolation control circuit 40 are similar to those in memory mat 7 already described in connection with the background of the invention with reference to FIG. 2, and therefore, description thereof is not repeated.

Memory cells 60a, 70a and 100a are the same as memory cells 60, 70 and 100 in the second and third embodiments except for that a cell plate potential VCPA is applied thereto. Memory cells 50b, 80b and 90b are the same as memory cells 50, 80 and 90 in the second and third embodiments except for that a cell plate potential VCPB is applied thereto.

Thus, memory cells 50b, 60a, 70a, 80b, 90b and 10a in the fourth embodiment are configured such that memory cells 60a, 70a and 100a connected to bit line BL are supplied with cell plate potential VCPA, and memory cells 50b, 80b and 90b connected to bit line /BL are supplied with cell plate potential VCPB.

Cell plate potentials VCPA and VCPB are different from each other only in the sense amplifier delay mode, and are equal to each other in the normal mode. Thus, memory cells 50b, 60a, 70a, 80b, 90b and 100a in the fourth embodiment are equivalent to memory cells 50, 60, 70, 80, 90 and 100 in the second embodiment when the operation is in the normal mode. Cell plate potentials VCPA and VCPB can be externally controlled, e.g., by directly applying them via external pins.

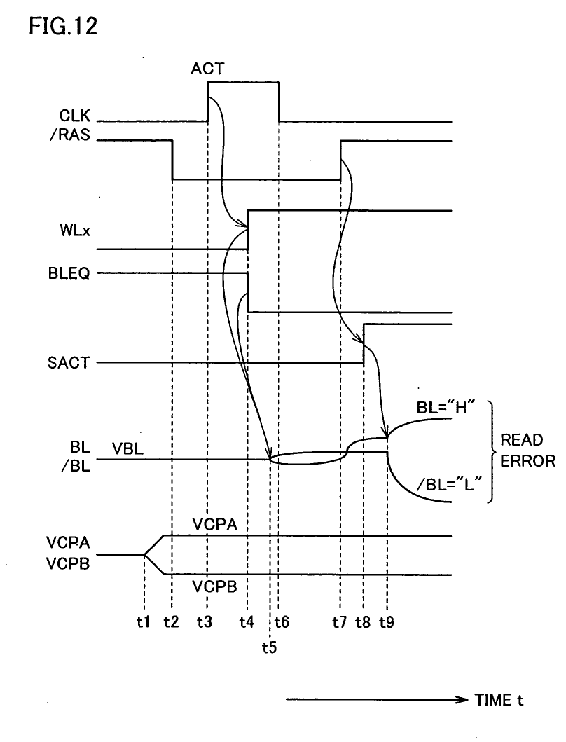

FIG. 12 is a timing chart illustrating a circuit operation of memory cell 70a in memory mat 7D of the fourth embodiment shown in FIG. 11.

FIG. 12 illustrates the operation in the sense amplifier delay mode after time t1.

At time t1, cell plate potentials VCPA and VCPB, which have been equal to each other, shift toward the H- and L-levels, respectively.

At time t2, externally applied row address strobe signal /RAS (see FIG. 1) attains the L-level.

At time t3, externally applied clock signal CLK (see FIG. 1) attains the H-level, and the ACT command is issued. In response to this ACT command, word line WLx rises to the H-level at time t3.

Simultaneously with the rising of word line WLx to the H-level at time t4, bit line equalize signal BLEQ falls to the L-level. In response to the rising of word line WLx to the H-level, data is read from memory cell 70a in FIG. 11 onto bit line BL. Also, in response to the falling of bit line equalize signal BLEQ to the L-level, bit line pair BL and /BL enters the floating state.

Since the data is read onto the floating bit line BL as described above, the potentials on paired bit lines BL and /BL shift toward the L- and H-levels at time t5, respectively.

At time t6, clock signal CLK attains the L-level. At time t7, row address strobe signal /RAS attains the H-level. In response to the H-level of row address strobe signal /RAS attained at time t7, sense amplifier activating signal SACT rises to the H-level at time t8.

In response to the rising of sense amplifier activating signal SACT to the H-level at time t8, sense amplifier 20 in FIG. 11 amplifies the minute potential difference on bit line pair BL and /BL at time t9.

Since WL-BC(BL) shorting and WL-SC(SN) shorting are present in memory cell 70a, the potentials on bit lines BL and /BL, which shifted toward the L- and H-levels at time t5, respectively, are affected by the minute current flowing from word line WLx to bit line BL, and thereby the potential on bit line BL changes from the L-level toward the H-level with time.

Therefore, when the minute potential difference between paired bit lines BL and /BL is amplified at time t9, paired bit lines BL and /BL attain the H- and L-levels, respectively. Consequently, a read error reflecting the WL-BC(BL) shorting and WL-SC(SN) shorting in memory cell 70a is detected.

In the sense amplifier delay mode of the fourth embodiment, cell plate potentials VCPA and VCPB are different from each other. Therefore, the potentials on storage nodes SN (already illustrated with reference to FIG. 3B) in memory cells 60a, 70a and 100a, which are connected to bit line BL, shift toward the H-level, and the potentials on storage nodes SN in memory cells 50b, 80b and 90b, which are connected to bit line /BL, shift toward the L-level.

Accordingly, in the sense amplifier delay mode of the fourth embodiment, the potentials on paired bit lines BL and /BL change toward the H- and L-levels, respectively, when the data is read onto the floating bit line BL at time t5. Therefore, the potential difference between paired bit lines BL and /BL, on which potentials shift toward the L- and H-levels at time t5, respectively, decreases and the potential on bit line BL changes relatively rapidly from the L-level to the H-level.

Thereby, a read error reflecting the WL-BC(BL) shorting and WL-SC(SN) shorting in memory cell 70 can be detected further rapidly.

According to the fourth embodiment, as described above, a potential difference is caused between cell plate potentials VCPA and VCPB, which are present on the memory cells connected to bit lines BL and /BL, respectively so that circuit faults can be detected further rapidly without increasing the circuit area.

The structure and manner already described in connection with the fourth embodiment can be applied to the semiconductor memory device having the single-memory-cell structure, e.g., of the first embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor memory device of a single-memory-cell structure having a test mode for testing an operation state, comprising:
a plurality of word lines arranged in a row direction;
a bit line pair arranged in a column direction;
a plurality of memory cells configured such that only one of the memory cells on each of said plurality of word lines is arranged for the bit line pair, and corresponds to one bit line alternately in said pair;
a bit line equalize circuit equalizing potentials on said bit line pair; and
a bit line isolation control circuit performing electrical connection and isolation of said paired bit lines, wherein
said bit line equalize circuit or said bit line isolation control circuit can control the potential on each of the paired bit lines independently of the other in the test mode.

2. A semiconductor memory device of a twin-memory-cell structure having a test mode for testing an operation state, comprising:
a plurality of word lines arranged in a row direction;
a bit line pair arranged in a column direction;
a plurality of memory cells configured such that two of the memory cells arranged on each of said plurality of word lines correspond to the paired bit lines, respectively;
a bit line equalize circuit equalizing potentials on said bit line pair; and
a bit line isolation control circuit performing electrical connection and isolation of said paired bit lines, wherein
said bit line equalize circuit or said bit line isolation control circuit can control the potential on each of the paired bit lines independently of the other in the test mode.

3. The semiconductor memory device according to claim 1, wherein
said bit line equalize circuit equalizes one and the other of said paired bit lines to first and second bit line potentials in response to a bit line equalize signal, respectively.

4. The semiconductor memory device according to claim 2, wherein
said bit line equalize circuit equalizes one and the other of said paired bit lines to first and second bit line potentials in response to a bit line equalize signal, respectively.

5. The semiconductor memory device according to claim 1, wherein
said bit line isolation control circuit performs electrical connection and isolation of one of said paired bit lines in accordance with a first bit line isolating signal, and performs electrical connection and isolation of the other of said paired bit lines in accordance with a second bit line isolating signal.

6. The semiconductor memory device according to claim 2, wherein
said bit line isolation control circuit performs electrical connection and isolation of one of said paired bit lines in accordance with a first bit line isolating signal, and performs electrical connection and isolation of the other of said paired bit lines in accordance with a second bit line isolating signal.

7. The semiconductor memory device according to claim 1, wherein
said bit line equalize circuit equalizes one and the other of said paired bit lines in accordance with first and second bit line equalize signals, respectively.

8. The semiconductor memory device according to claim 2, wherein
said bit line equalize circuit equalizes one and the other of said paired bit lines in accordance with first and second bit line equalize signals, respectively.

9. A semiconductor memory device having a test mode for testing an operation state, comprising:
a plurality of word lines arranged in a row direction;
a bit line pair arranged in a column direction;
a first memory cell group connected to one of said paired bit lines supplied with a first cell plate potential; and
a second memory cell group connected to the other of said paired bit lines supplied with a second cell plate potential.

10. The semiconductor memory device according to claim 9, wherein
said semiconductor memory device has a single-memory-cell structure configured such that only one of the memory cells on each of said plurality of word lines is arranged for said bit line pair, and corresponds to one bit line alternately in said pair.

11. The semiconductor memory device according to claim 9, wherein
said semiconductor memory device has a twin-memory-cell structure configured such that two of the memory cells on each of said plurality of word lines correspond to said paired bit lines, respectively.
